(19) United States
(12) Patent Application Publication
(10) Pub. No.: US 2012/0160642 A1
(43) Pub. Date: Jun. 28, 2012

(54) SWITCH UNIT

(75) Inventor: Hung-Min Liao, Luzhou City (TW)

(73) Assignee: Hung-Min Liao, Luzhou City (TW)

(21) Appl. No.: 12/976,781

(22) Filed: Dec. 22, 2010

(51) Int. Cl. H01H 9/02

(52) U.S. Cl. 200/310

(57) ABSTRACT

A switch unit comprises a switch base, a trigger member disposed over the switch base, a light emitting element provided in the inner space of the trigger member, and a head cap. The head cap is capable of being coupled with or being separated from the trigger member, and is capable of being coupled with or being separated from the trigger member via a cap adapter. Thus, the trigger member is assembled directly with various types of head caps, or is assembled with various types of head caps via the cap adapter.

### FIELD OF THE INVENTION

The present invention relates to a switch unit, and more particularly, to a switch unit which enables combinations of switches and head caps with different sizes and/or shapes.

### BACKGROUND OF THE INVENTION

In the modern commercial market that the products are rapidly changed, a switch device is one of puzzles for product designers to design such a variety kinds of switches with different sizes and different product specifications in different applied fields. Switches are applied in many different electronic instruments, mechanical equipments, and control apparatus, if we observe ourselves use different kinds of switches whenever driving, listening to music, making a phone call or at work.

Each of these switches has a trigger portion. A user triggers the trigger portion of a switch to activate or disable an electronic instrument, mechanical equipments, or a control apparatus. It is provided a head cap on the trigger portion of the switch for a user to conveniently contact or pushing the trigger portion.

Conventionally, the head cap is integrally formed on the trigger portion of the switches, and the sizes and dimensions of the head caps are formed different in correspondence to the different kinds of switches. In other words, the entire switch is inevitable to be reshaped when there is a need only to change the head cap thereof. On the other hand, it is impossible to hope the manufacturers develop every kind of molds for switches, so it thus becomes difficult to find a suitable switch when needed.

### SUMMARY OF THE INVENTION

Therefore, the present invention has been made in view of the above circumstances and provides a switch unit in which a cap adapter is the perfect match between a switch base and a head cap, so that combinations of the head cap and the switch base with different size, usage, feedback, shape, and color can be realized and developments of new switches and new head caps can be easily increased, respectively.

A switch unit according to one embodiment of the present invention comprises: a switch base; a trigger member disposed over the switch base, the trigger member comprising: a periphery wall extending upward from the switch base, an inner space provided within an inner side of the periphery wall and surrounded by the periphery wall, and a periphery flange disposed surrounding an upper end of the periphery wall; a light emitting element provided in the inner space of the trigger member; and a head cap having a lower coupling flange extending downward from the head cap for assembling with the periphery flange of the trigger member, whereby coupling the head cap with or separating the head cap with the trigger member, the trigger member is assembled with various types of head caps.

According to an embodiment of the present invention, the head cap may further have a coupling portion provided on the lower coupling flange of the head cap.

According to an embodiment of the present invention, the head cap may be made of a transparent material.

According to an embodiment of the present invention, the head cap may further have an upper opening connected with the inner space of the trigger member.

According to an embodiment of the present invention, the head cap may further have a concave slit provided on the periphery wall.

A switch unit according to another embodiment of the present invention unit comprises: a switch base; a trigger member disposed over the switch base, the trigger member comprising: a periphery wall extending upward from the switch base, an inner space provided at the inner side of the periphery wall and surrounded by the periphery wall, and a periphery flange disposed surrounding an upper end of the periphery wall; a light emitting element provided in the inner space of the trigger member; a cap adapter comprising an adapter body, a through hole penetrating through the adapter body from the bottom of the adapter body and connected with the inner space of the trigger member, and an engaging wall extending downward from the bottom of the adapter body and surrounding the through hole, wherein the engaging wall is engaged with the periphery wall of the trigger member by a clip portion provided on the trigger member and a position limiting portion, the limiting portion is either provided on the cap adapter or on the trigger member provided; and a head cap assembled with the cap adapter and covering the through hole of the cap adapter, whereby coupling the cap adapter with or separating the cap adapter from the trigger member, and by coupling the head cap with or separating the head cap from the cap adapter, the trigger member is assembled with various types of the head caps via the cap adapter.

According to an embodiment of the present invention, the cap adapter may further have an upper coupling flange provided on the top of the adapter body and surrounding the through hole, and the head cap may further have a lower coupling flange for coupling with the upper coupling flange of the cap adapter.

According to an embodiment of the present invention, the clip portion may be a bard lump.

According to an embodiment of the present invention, the position limiting portion may be a rib flange provided on the cap adapter.

According to an embodiment of the present invention, the position limiting portion may be a rib flange provided on the trigger member.

According to an embodiment of the present invention, the head cap may be made of a transparent material.

According to an embodiment of the present invention, the head cap may further have an upper opening connected with the through hole of the cap adapter and the inner space of the trigger member.

According to an embodiment of the present invention, the periphery wall may further have a concave slit.

According to an embodiment of the present invention, the cap adapter may further include a reflective film formed on an inner wall of the through hole.

According to an embodiment of the present invention, the switch unit may further comprise a light adjusting element disposed in the through hole of the cap adapter.

According to those embodiments of the present invention described above, the head cap is capable of separating from the trigger member even if the switch base and the trigger member disposed over the switch are fixed to an external device. Thereby, it is possible that the head cap is replaced by a new one having different shape and/or color for combining to the trigger member and the switch base. In additional, replacing the head cap with a new one having desired size can be realized through a cap adapter having different configurations so that the configurations of the head cap will not be limited by the configurations of the switch base and trigger element.

Further, various kinds of the light adjusting elements (e.g., a light divergent element, a light condensing element, and a color filter.) and various kinds of the cap heads may be provided in the cap adapter. Thereby, a light divergence angle and the color of light emitted by the light emitting element can be adjusted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view illustrating a switch unit of a first embodiment according to the present invention;

FIG. 2 is a perspective cross-section view illustrating the switch unit of the first embodiment according to the present invention;

FIG. 3 is a perspective cross-section view illustrating a switch unit of a second embodiment according to the present invention;

FIG. 4 is a perspective view illustrating a switch unit of a third embodiment according to the present invention;

FIG. 5 is a perspective cross-section view illustrating the switch unit of the third embodiment according to the present invention;

FIG. 6 is a perspective cross-section view illustrating a switch unit of a fourth embodiment according to the present invention;

FIG. 7 is a perspective cross-section view illustrating a switch unit of a fifth embodiment according to the present invention; and

FIG. 8 is a perspective cross-section view illustrating a switch unit of a sixth embodiment according to the present invention.

### DETAILED DESCRIPTION OF THE PREFERRED EMBODIMENTS

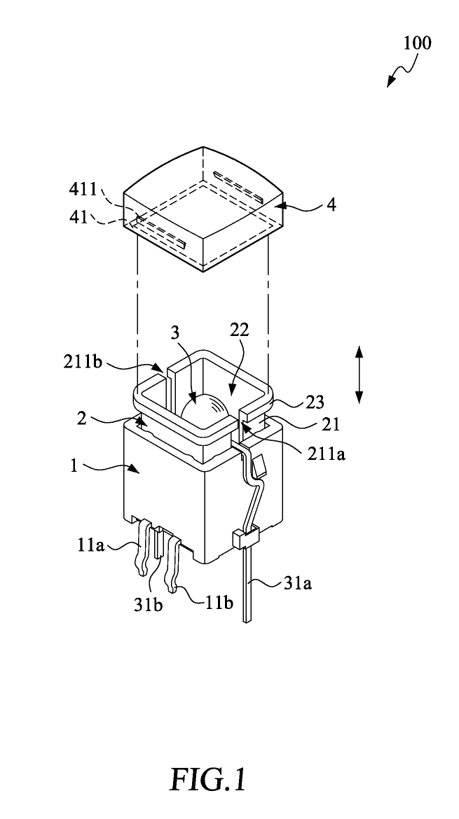

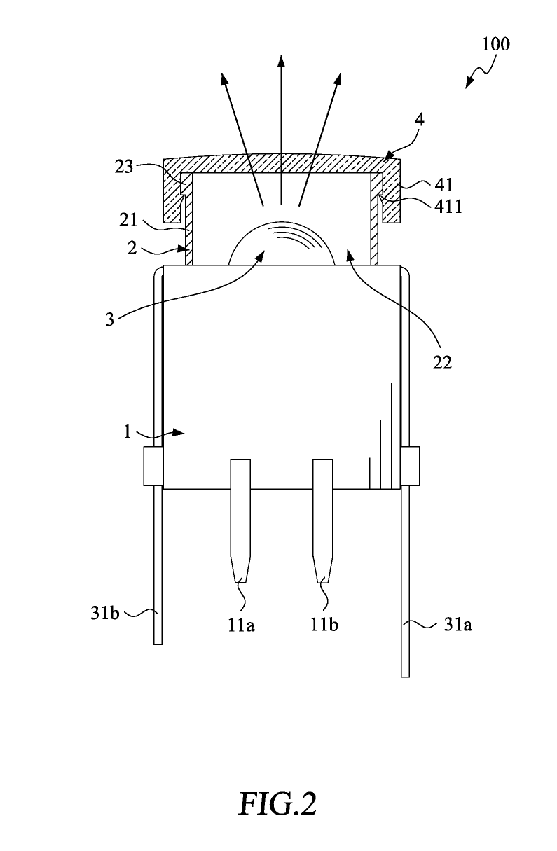

Please refer to FIG. 1 and FIG. 2. FIG. 1 is a perspective view illustrating a switch unit of a first embodiment according to the present invention. FIG. 2 is a perspective cross-section view illustrating the switch unit of the first embodiment according to the present invention.

As illustrated in FIG. 1 and FIG. 2, a switch unit 100 of the first embodiment according to the present invention includes a switch base 1, a trigger member 2, a light emitting element 3, and a head cap 4. Specifically, the switch unit 100 is an illuminated switch. In particular, the switch unit 100 is a LED (light emitting diode) illuminated switch.

The switch base 1 has two connecting pins 11a and 11b for connecting to electronic instruments, mechanical equipments, or control apparatus (not shown). However, the present invention is not limited to this. The switch base 1 may have two or more connecting pins.

The trigger member 2 is disposed over the switch base 1. The trigger member 2 has a periphery wall 21 extending upward from the switch base 1, an inner space 22 provided within an inner side of the periphery wall 21 and surrounded by the periphery wall 21, and a periphery flange 23 disposed surrounding an upper end of the periphery wall 21. The trigger member 2 is able to move up and down relative to the switch base 1 so as to turn on or turn off a circuit electrically connected with the connecting pin 11a and 11b of the switch base 1.

The light emitting element 3 is provided in the inner space 22 of the trigger member 2 and is a LED provided with a pair of power supply pins 31a and 31b. In this embodiment, the periphery wall 21 has two concave slits 211a and 211b. The power supply pins 31a and 31b of the light emitting element 3 are elongated toward outside through the concave slits 211a and 211b so as to be electrically connected to an outside circuit (not shown).

The head cap 4 is provided over the trigger member 2 and covers the inner space 22 of the trigger member 2. The head cap 4 has a lower coupling flange 41 elongated downward from the head cap 4 and facing the periphery flange 23 of trigger member 2. By coupling the lower coupling flange 41 to the periphery flange 23 of the trigger member 2, the head cap 4 can be assembled with the trigger member 2. Preferably, the head cap 4 may further have a coupling portion 411 provided on the lower coupling flange 41. By the coupling portion 411, the lower coupling flange 41 of head cap 4 can be coupled to the periphery flange 23 of the trigger member 2.

Preferably, the head cap 4 may be made of a transparent material. Thereby, a light emitted by the light emitting element 3 may travel through the inner space 22, to pass through the head cap 4, and then to transmit to the external. Moreover, the head cap 4 made of a transparent material may be provided with different colors. Thus, the light emitted by the light emitting element 3 can be transferred into a light having one of the different colors depending on which color the transparent material of the head cap 4 is.

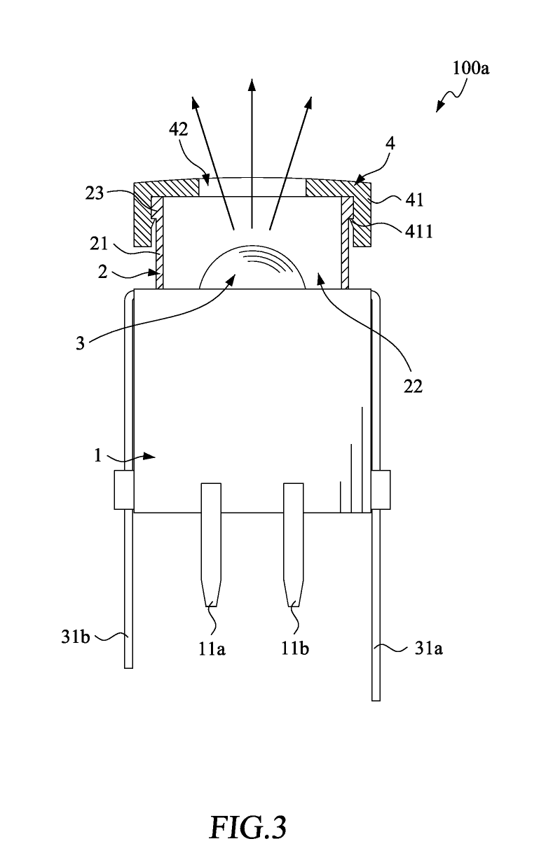

Further, referring to FIG. 3, a head cap 4 of a switch unit 100a may be provided with an upper opening 42. Thereby, a light emitted by the light emitting element 3 may travel through the inner space 22 to the upper opening 42, and then to transmit to the external.

Because the head cap 4 is assembled with the trigger member 2 by the lower coupling flange 41, the head cap 4 can be separated from the trigger member 2. Thereby, the head cap 4 may be replaced by a new one having different design and/or color. Thus, by separate modular design, the present invention is beneficial in that the switch base, the trigger member, and the head cap can be more easily developed without considering the cost of mold.

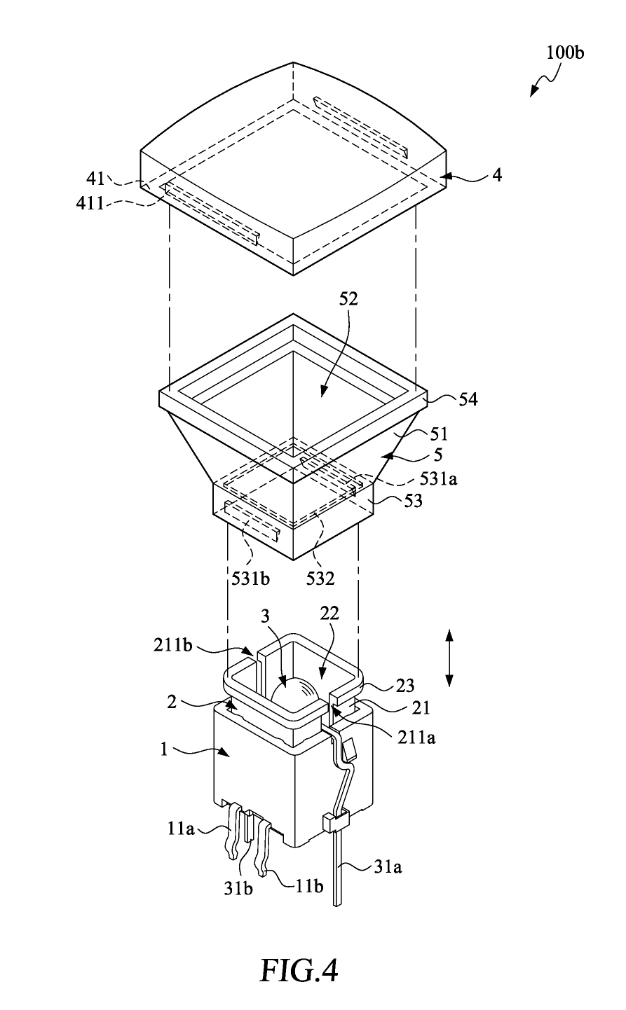

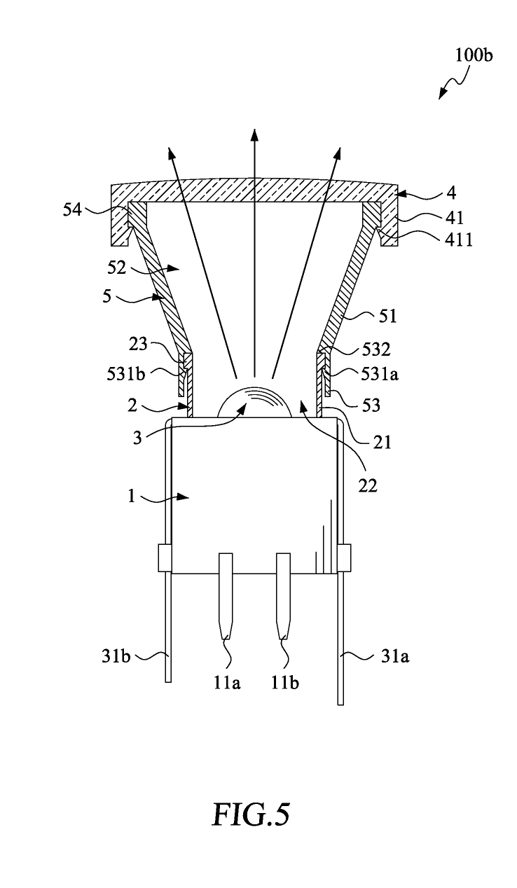

Please refer to FIG. 4 and FIG. 5. FIG. 4 is a perspective view illustrating a switch unit of a third embodiment according to the present invention. FIG. 5 is a perspective cross-section view illustrating the switch unit of the third embodiment according to the present invention.

As illustrated in FIG. 4 and FIG. 5, a switch unit 100b of the third embodiment according to the present invention further includes a cap adapter 5 in addition to the switch base 1, the trigger member 2, the light emitting element 3, and the head cap 4 described above.

The cap adapter 5 has an adapter body 51, a through hole 52, an engaging wall 53, and an upper coupling flange 54.

The size and shape of the bottom of the adapter body 51 is matched to the size and shape of the trigger member 2 for coupling with the trigger member 2. And, the adapter body 51 is provided to allow the top portion thereof having the size and shape different from those of the bottom, so as to assemble the head cap 4 and the trigger member 2 with different size and shape.

The through hole 52 is formed penetrating through the adapter body 51 from the top of the adapter body 51 to the bottom thereof and is thereafter connected with the inner space 22 of the trigger member 2. Thus, a light emitted by the light emitting element 3 may travel through the inner space 22 and the through hole 52 to the external.

The engaging wall 53 extending downward from the bottom of the adapter body 51 is provided and is disposed surrounding the through hole 52. The engaging wall 53 is engaged with the periphery wall 23 of the trigger member 2 by a pair of clip portions 531a and 531b provided on the inner surface of the engaging wall 53 and a position limiting portion 532.

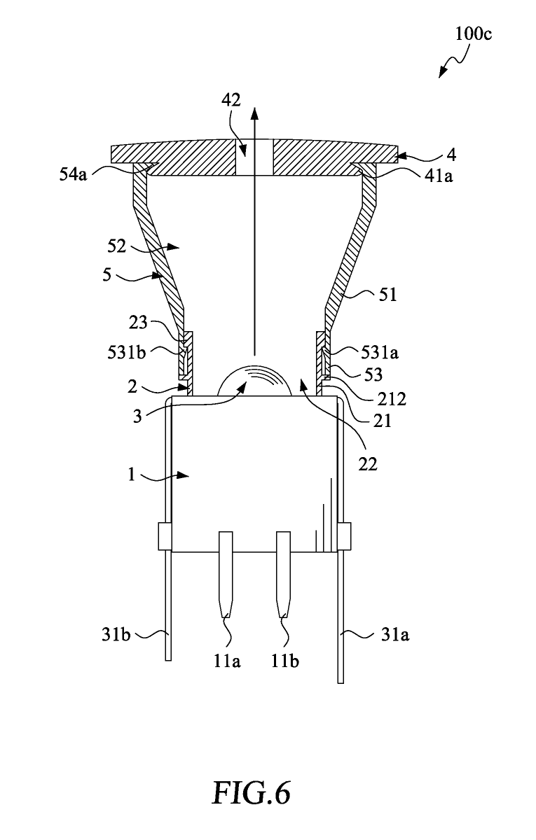

Preferably, each of the clip portions 531a and 531b may be a bard lump. The bard lump is engaged to the periphery flange 23 of the trigger member 2 when the cap adapter 5 is assembled with the trigger member 2. However, the present invention is not limited to this. The number of the clip portion may be one or more. Besides, the position limiting portion 532 may be a rib flange, which surrounds the cap adapter 5 and is provided on an inner surface of the engaging wall 53. The position limiting portion 532 is used for limiting the position of the cap adapter 5 and the trigger member 2 for preventing slip between the cap adapter 5 and the trigger member 2 so that the cap adapter 5 can be more tightly assembled. However, the present invention is not limited to this. As illustrated in FIG. 6, a position limiting portion 212 may be provided on the trigger member 2 as well.

The cap adapter 5 can be separated from the trigger member 2 because the cap adapter 5 is coupled to the trigger member 2 by the engaging wall 53, the clip portions 531a and 531b, and the position limiting portion 532. Thus, the cap adapter 5 can be replaced by a new one with different other design even if the switch base 1 and trigger member 2 disposed on the switch base 1 have been connected with an external device.

The upper coupling flange 54 for coupling with head cap 4 is provided on the top of the adapter body 51 and surrounds the through hole 52.

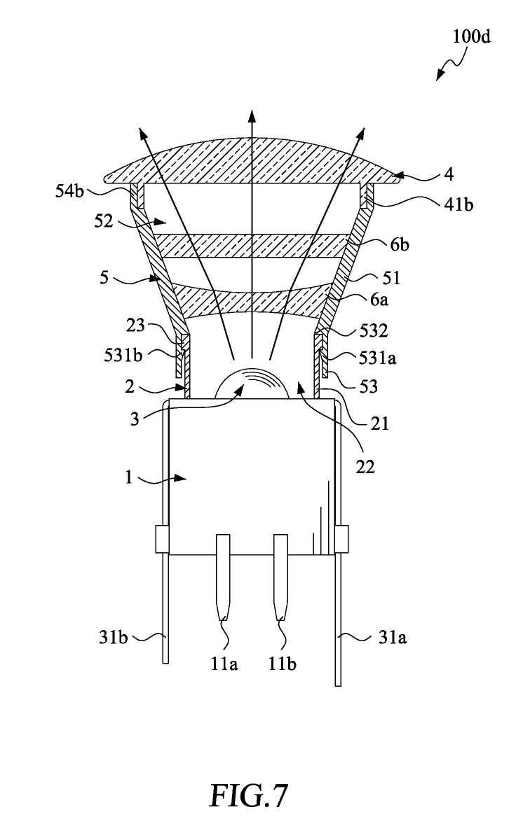

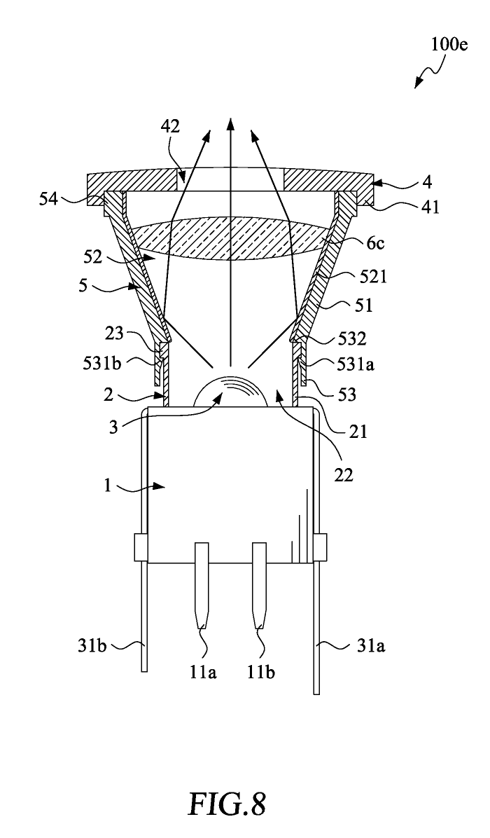

In this embodiment, the head cap 4 is provided over the cap adapter 5 and covers the through hole 52 of the cap adapter 5. The lower coupling flange 41 of the head cap 4 is provided to match with the upper coupling flange 54 of the cap adapter 5, and thus they are assembled with each other. The coupling portion 411 of the lower coupling flange 41 is a bard lump similar to the clip portions 531a and 531b of the engaging wall 53. The lower coupling flange 41a may be a convex flange as illustrated in FIG. 6, which is embedded in the inner wall of the upper coupling flange 54a of the cap adapter 5. The lower coupling flange 41b may be a lump as illustrated in FIG. 7, which is engaged with the inner wall of the upper coupling flange 54a. And in the other embodiment as shown in FIG. 8, the lower coupling flange may be not provided.

Preferably, the head cap 4 may be made of a transparent material. Thereby, a light emitted by the light emitting element 3 may travel through the inner space 22 and the through hole 52, to pass through the head cap 4, and then to transmit to the external. Moreover, a switch unit 100c may be provided with the head cap 4 having an upper opening 42 as illustrated in FIG. 6.

The head cap 4 can be separated from the cap adapter 5 because the head cap 4 is assembled with the cap adapter 5 by the lower coupling flange 41. Thereby, the head cap 4 may either be replaced by a new one having different shape and/or color or be replaced by a new one having different size through various kinds of the cap adapters. The shape, color and size of the head cap 4 are not limited by those of the switch base 1 and the trigger member 2. Therefore, it thus achieves a goal that a head cap with a smaller size is assembled with a trigger member with a larger size via a cap adapter. Or a head cap with a larger size is assembled with a trigger member with a smaller size via a cap adapter. Or a head cap with a circular shape is assembled with a trigger member with a rectangular shape via a cap adapter.

Please refer to FIG. 6. FIG. 6 is a perspective cross-section view illustrating a switch unit of a fourth embodiment according to the present invention. The elements of switch unit 100c in this embodiment are similar to those in the first embodiment. The same elements in the fourth embodiment are labeled with the same reference numbers as in the first embodiment.

In this embodiment, the periphery wall 21 of the trigger member 2 is provided with a position limiting portion 212 which is used for preventing slip between the cap adapter 5 and the trigger member 2.

The lower coupling flange 41a of the head cap 4 is a convex flange, which is embedded in the inner wall of the upper coupling flange 54a of the cap adapter 5. The head cap 4 has the upper opening 42, which is connected with the through hole 52 of the cap adapter 5 and the inner space 22 of the trigger member 2. Thus, a light emitted by the light emitting element 3 may travel through the inner space 22, the through hole 52, and the upper opening 42 to the external.

Please refer to FIG. 7. FIG. 7 is a perspective cross-section view illustrating a switch unit of a fifth embodiment according to the present invention. The elements of switch unit 100d in this embodiment are similar to those in the first embodiment. The same elements in the fifth embodiment are labeled with the same reference numbers as in the first embodiment.

In this embodiment, the through hole 52 of the cap adapter 5 is provided with light adjusting elements 6a and 6b, which is used for adjusting a light emitted by the light emitting element 3. The light adjusting element 6a is a light divergent element (e.g., a concave lens). The light adjusting element 6b is a color filter (e.g., a color filter plate). Thereby, a light divergence angle and color of the light emitted by the light emitting element 3 can be adjusted. However, the present invention is not limited to the description above. A light adjusting element 6c which is a light condensing element (e.g., a convex lens) as illustrated in FIG. 8 may be provided. In addition, the head cap 4 is made of a transparent material, and the head cap 4 is provided with a top portion having a curve shape. Thereby, a light divergence angle of the light emitted by the light emitting element 3 can be adjusted by the head cap 4.

Please refer to FIG. 8. FIG. 8 is a perspective cross-section view illustrating a switch unit of a sixth embodiment according to the present invention. The elements of switch unit 100e in this embodiment are similar to those in the first embodiment. The same elements in the sixth embodiment are labeled with the same reference numbers as in the first embodiment.

In this embodiment, a light adjusting element 6c is provided in the through hole 52 of the cap adapter 5. The light adjusting element 6c is a light condensing element (e.g., a convex lens). Besides, a reflective film 521 formed on an inner wall of the through hole 52 is provided. A light emitted by the light emitting element 3 may be reflected by the reflective film 521, and is condensed by the light adjusting element 6c to travel through the upper opening 42, and then transmit to the external. Thereby, the intensity of the light emitting to the external is improved.

As can be appreciated from the above embodiments, the switch unit of the present invention has industry worth which meets the requirement for a patent. The above description should be considered as only the discussion of the preferred embodiments of the present invention. However, a person skilled in the art may make various modifications to the present invention. Those modifications still fall within the spirit and scope defined by the appended claims.

What is claimed is:

1. A switch unit, comprising:
a switch base;
a trigger member disposed over the switch base, the trigger member comprising: a periphery wall extending upward from the switch base, an inner space provided within an inner side of the periphery wall and surrounded by the periphery wall, and a periphery flange disposed surrounding an upper end of the periphery wall;
a light emitting element provided in the inner space of the trigger member; and
a head cap having a lower coupling flange extending downward from the head cap for assembling with the periphery flange of the trigger member,
whereby coupling the head cap with or separating the head cap from the trigger member, the trigger member is assembled with various types of head caps.

2. The switch unit as claimed in claim 1, wherein the head cap further has a coupling portion provided on the lower coupling flange of the head cap.

3. The switch unit as claimed in claim 1, wherein the head cap is made of a transparent material.

4. The switch unit as claimed in claim 1, wherein the head cap further has an upper opening connected with the inner space of the trigger member.

5. The switch unit as claimed in claim 1, wherein the periphery wall of the trigger member has a concave slit.

6. A switch unit, comprising:
a switch base;
a trigger member disposed over the switch base, the trigger member comprising: a periphery wall extending upward from the switch base, an inner space provided within the inner side of the periphery wall and surrounded by the periphery wall, and a periphery flange disposed surrounding an upper end of the periphery wall;
a light emitting element provided in the inner space of the trigger member;
a cap adapter comprising an adapter body, a through hole formed penetrating through the adapter body from the top of the adapter body to the bottom thereof and thereafter connected with the inner space of the trigger member, and an engaging wall extending downward from the bottom of the adapter body and surrounding the through hole, wherein the engaging wall is engaged with the periphery wall of the trigger member by a clip portion provided on the engaging wall and a position limiting portion, the position limiting portion is either provided on the cap adapter or on the trigger member; and a head cap assembled with the cap adapter and covering the through hole of the cap adapter,
whereby coupling the cap adapter with or separating the cap adapter from the trigger member, and by coupling the head cap with or separating the head cap from the cap adapter, the trigger member is assembled with various types of head caps via the cap adapter.

7. The switch unit as claimed in claim 6, wherein the cap adapter further has an upper coupling flange provided on the top of the adapter body and surrounding the through hole, and the head cap further has a lower coupling flange for coupling with the upper coupling flange of the cap adapter.

8. The switch unit as claimed in claim 6, wherein the clip portion is a bard lump.

9. The switch unit as claimed in claim 6, wherein the position limiting portion is a rib flange provided on the cap adapter.

10. The switch unit as claimed in claim 6, wherein the position limiting portion is a rib flange provided on the trigger member.

11. The switch unit as claimed in claim 6, wherein the head cap is made of a transparent material.

12. The switch unit as claimed in claim 6, wherein the head cap further has an upper opening connected with the through hole of the cap adapter and the inner space of the trigger member.

13. The switch unit as claimed in claim 6, wherein the periphery wall of the trigger member has a concave slit.

14. The switch unit as claimed in claim 6, wherein the cap adapter further includes a reflective film formed on an inner wall of the through hole.

15. The switch unit as claimed in claim 6, further comprising a light adjusting element disposed in the through hole of the cap adapter.
